(19) United States
(12) Patent Application Publication
(10) Pub. No.: US 2026/0002688 A1
(43) Pub. Date: Jan. 1, 2026

(54) Modeling Methods And Methods For Evaluating Energy Conservation Effect

(71) Applicant: Siemens Schweiz AG, Zürich (CH)

(72) Inventors: Tian Rui Sun, Beijing (CN); Chao Chun Li, Shanghai (CN); Jing Li, Shanghai (CN); Ling Fu, Shanghai (CN)

(73) Assignee: Siemens Schweiz AG, Zürich (CH)

(21) Appl. No.: 19/106,063

(22) PCT Filed: Aug. 31, 2022
(86) PCT No.: PCT/CN2022/116367

§ 371 Date: Feb. 24, 2025

(51) Int. Cl. F24F 11/47; F24F 11/64; F24F 130/10; G06Q 50/06

(52) U.S. Cl. CPC F24F 11/47; F24F 11/64; G06Q 50/06; F24F 2130/10

(57) ABSTRACT

Embodiments of this application mainly relate to the field of energy conservation, and in particular, to modeling methods and methods for evaluating an energy conservation effect. A BES template library is established according to a building purpose, an ECM combination, and a type of HVAC system, the BES template library including a plurality of BES model templates. A purpose, an applied ECM, a type of HVAC system, and specified characteristic parameters of a target building are received. A first template is determined by retrieving a template with highest similarity to the target building from the BES template library according to the purpose, the applied ECM, and the type of HVAC system of the target building. A simplified BES model of the target building is obtained by modifying corresponding characteristic parameters in the first template according to the specified characteristic parameters of the target building.

### CROSS-REFERENCE TO RELATED APPLICATIONS

This application is a U.S. National Stage Application of International Application No. PCT/CN2022/116367 filed Aug. 31, 2022, which designates the United States of America, the contents of which are hereby incorporated by reference in their entirety.

### TECHNICAL FIELD

Teachings of this disclosure mainly relate to energy conservation. Various embodiments of the teachings herein include modeling methods, method for evaluating an energy conservation effects, electronic devices, and readable media.

### BACKGROUND

Construction is an essential cornerstone for sustaining human life, which not only provides buildings for people to live and infrastructure for people to use but also plays an important role in response to the climate crisis. With an increasing degree of urbanization, the carbon emission amount from a building is rising, and energy conservation renovation for a building with high energy consumption is an effective means to reduce the carbon emission amount of the building. An evaluation of energy conservation measures applied to a building is basic work of the energy conservation renovation. At present, a manner is to establish an empirical formula based on average performance of similar projects in the past. However, the determination of the empirical formula is highly dependent on a large amount of project experience and historical data. Meanwhile, there is often a certain difference between different buildings, and thus an evaluation value of energy conservation effect obtained based on the empirical formula is relatively different from an actual value.

### SUMMARY

Various embodiments of the teachings of the present disclosure include modeling methods, methods for evaluating an energy conservation effect, electronic devices, and readable media, to quickly and accurately evaluate an energy conservation measure applied to a building.

For example, some embodiments include a method for generating a training data set including: establishing a building energy simulation (Building Energy Simulation, BES) template library according to a building purpose, an energy conservation measure (Energy Conservation Measure, ECM) combination, and a type of HVAC (heating, ventilation and air conditioning) system, the BES template library including a plurality of BES model templates; receiving a purpose, an applied ECM, a type of HVAC system, and specified characteristic parameters of a target building; determining a first template by retrieving a template with highest similarity to the target building from the BES template library according to the purpose, the applied ECM, and the type of HVAC system of the target building; and obtaining a simplified BES model of the target building by modifying corresponding characteristic parameters in the first template according to the specified characteristic parameters of the target building.

For example, some embodiments include a method for evaluating an energy conservation effect including: obtaining a first simplified model by the modeling method according to the first aspect, the first simplified model referring to a simplified BES model of a target building in a case of applying a current ECM condition; obtaining a second simplified model by the modeling method according to the first aspect, the second simplified model referring to a simplified BES model of the target building in a case of applying a planned ECM condition; respectively predicting energy consumption of the first simplified model and energy consumption of the second simplified model by a BES solver; and calculating, according to the energy consumption of the first simplified model and the energy consumption of the second simplified model, energy consumption that the target building saves in a case of transitioning from the current ECM condition to the planned ECM condition.

For example, some embodiments include an electronic device including: at least one memory, configured to store computer-readable code; and at least one processor, configured to invoke the computer-readable code, to perform one or more of the methods described herein.

For example, some embodiments include a computer-readable medium storing computer-readable instructions, the computer-readable instructions, when being executed by a processor, causing the processor to perform one or more of the methods described herein.

### BRIEF DESCRIPTION OF THE DRAWINGS

The following drawings are only intended to illustrate and explain example embodiments of this application, but are not intended to limit the scope of this application.

FIG. 1 is a flowchart of an example modeling method incorporating teachings of the present disclosure;

FIG. 2 is a flowchart of an example method for evaluating an energy conservation effect incorporating teachings of the present disclosure;

FIG. 3A is a schematic diagram of an area ratio of an inner zone of building incorporating teachings of the present disclosure;

FIG. 3B is a regression curve of an area ratio of an inner zone of building and an annual total load of building incorporating teachings of the present disclosure; and

FIG. 4 is a schematic diagram of an example electronic device incorporating teachings of the present disclosure.

### DESCRIPTION OF REFERENCE NUMERALS

100: Modeling method;
101-104: Step of method;
200: Method for evaluating energy conservation effect;
201-204: Step of method;
400: Electronic device;
401: Memory;
402: Processor

### DETAILED DESCRIPTION

Example embodiments of the teachings of the present disclosure are described in more detail hereinafter with reference to the drawings. However, the concepts herein may be embodied in many different forms and are not to be construed as being limited to the embodiments illustrated herein. Rather, these embodiments are provided to make the present discussion thorough and complete and fully convey the scope of the concept of the present application to those skilled in the art. Throughout the preceding description and the drawings, like reference numerals refer to like elements.

It is to be understood that although terms such as first and second may be used herein to describe elements or operations, these elements or operations are not to be limited by these terms. These terms are only used to distinguish one element or operation from another. For example, without departing from the teachings of the present disclosure, a first feature may be referred to as a second feature, and similarly, the second feature may be referred to as the first feature.

The terms used herein are intended to describe particular embodiments and not to limit the concept of the present disclosure. As used herein, unless otherwise clearly indicated in the context, a singular form “a”, “one” or “the” is intended to include a plural form. It is to be further understood that the term “including” or “comprising” used in the specification specifies the existence of the described features, regions, parts, steps, operations, elements and/or components, without excluding the existence or addition of one or more other features, regions, parts, steps, operations, elements, components and/or combinations thereof.

Unless otherwise defined, all the terms (including technical and scientific terms) used herein have the same meanings as those commonly understood by those skilled in the art to which the present application pertains. It is to be further understood that terms, such as those defined in commonly used dictionaries, are to be interpreted as having meanings consistent with their meanings in the context of the related art and/or the present application and are not to be interpreted in an idealized or overly formal sense unless expressly so defined herein.

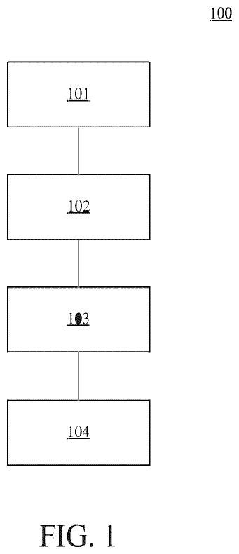

FIG. 1 is a flowchart of an example modeling method 100 incorporating teachings of the present disclosure. As shown in FIG. 1, the modeling method 100 includes:

Step 101: Establish a BES template library according to a building purpose, an ECM combination, and a type of HVAC system, the BES template library including a plurality of BES model templates. A plurality of specified building purposes, a plurality of specified ECM combinations, and a plurality of specified types of HVAC system may be selected. The plurality of specified types of HVAC system include: a plurality of specified heating and cooling source system forms, a plurality of specified terminal unit forms, and a plurality of specified transmission and distribution system forms. All combinations are obtained by performing arrangement and combination among any one of the plurality of specified building purposes, any one of the plurality of specified ECM combinations, any one of the plurality of specified heating and cooling source system forms, any one of the plurality of specified terminal unit forms, and any one of the plurality of specified transmission and distribution system forms. The BES model templates corresponding to each combination of the all combinations are established, and all the BES model templates are input into the BES template library.

In some embodiments, the plurality of specified building purposes may include: an office purpose and a commercial purpose. The plurality of specified ECM combinations may include: all combinations obtained by performing arrangement and combination among adopting/not adopting daylighting control, adopting/not adopting a heat recovery ventilation technology, and adopting/not adopting an air-side economizer technology. The plurality of specified heating and cooling source system forms include: a boiler/chiller system, a chiller with central heating system, a ground source heat pump system, and an air source heat pump system.

The plurality of specified terminal unit forms include: a FCU (Fan-coil Unit) system, and a VAV (Variable Air Volume) system. The plurality of specified transmission and distribution system forms include: a constant speed pump system, a variable speed pump system, and a secondary pump system. It is assumed that, a total of two specified building purposes are set, a total of eight ECM combinations are set (Group 1: adopting the daylighting control, adopting the heat recovery ventilation technology, and adopting the air-side economizer technology; Group 2: adopting the daylighting control, not adopting the heat recovery ventilation technology, and adopting the air-side economizer technology; . . . Group 8: not adopting the daylighting control, not adopting the heat recovery ventilation technology, and not adopting the air-side economizer technology), a total of four specified heating and cooling source system forms are set, a total of two specified terminal unit forms are set, and a total of three specified transmission and distribution system forms are set. After performing the arrangement and combination, 2×8×4×2×3=384 of combinations may be obtained.

In some embodiments, modifications may be further made on the basis of the foregoing building purposes/ECM combinations/types of HVAC system specified in detail. Optionally, the plurality of specified ECM combinations may contain various combinations among various typical classifications, for example, referring to relevant classifications involved in the BuildingSync and the building energy data exchange specification (the Building Energy Data Exchange Specification, BEDES) in the United States. Optionally, the templates in the template library may be further expanded according to actual needs of the user.

In some embodiments, a sensitivity analysis may be performed on each characteristic parameter in the characteristic parameters affecting energy consumption in the building, the sensitivity analysis referring to a calculation of a degree of influence on the energy consumption. Results of the sensitivity analysis corresponding to each characteristic parameter are sorted from high to low, and a preset number of characteristic parameters are selected as the specified characteristic parameters of the target building. Further, the characteristic parameters ranked in a first set of preset rankings, for example, the first to tenth place, may be selected as basic specified characteristic parameters of the target building; the characteristic parameters ranked in a second set of preset rankings, for example, the eleventh to twentieth place, may be selected as important specified characteristic parameters of the target building; and the characteristic parameters ranked in a third set of preset rankings, for example, the twenty-first to thirtieth place, may be selected as optional specified characteristic parameters of the target building. In some embodiments, the specified characteristic parameters of the target building may be selected from any one of the following: basic specified characteristic parameters; basic specified characteristic parameters and important specified characteristic parameters; and basic specified characteristic parameters, important specified characteristic parameters, and optional specified characteristic parameters.

Step 102: Receive a purpose, an applied ECM, a type of HVAC system, and specified characteristic parameters of a target building.

In some embodiments, a graphic user interface and/or an API interface may be provided to display related characteristic information read. In some embodiments, in a case that there is a first characteristic parameter in the specified characteristic parameters of the target building, the first characteristic parameter referring to a characteristic parameter that has no accurate reference value or is not measurable, a calibrated first characteristic parameter may be obtained by a simulation model calibration algorithm according to a historical energy bill of the target building. In some embodiments, the calibrated first characteristic parameter may be obtained through a calibration tool of adaptive model based on an optimization algorithm according to the historical energy bill of the target building.

Step 103: Determine a first template by retrieving a template with highest similarity to the target building from the BES template library according to the purpose, the applied ECM, and the type of HVAC system of the target building. A same template as the target building is retrieved from the BES template library; or a template with highest similarity to the target building is retrieved from the BES template library based on a Pearson correlation coefficient method.

Step 104: Obtaining a simplified BES model of the target building by modifying corresponding characteristic parameters in the first template according to the specified characteristic parameters of the target building. The specified characteristic parameters of the target building may include: basic building information, building envelope information, related information of an indoor energy-using equipment, and performance and configuration information of a HVAC system. Optionally, the basic building information may include a total building area, the number of floors, and an indoor personnel density. The building envelope information may include a heat transfer coefficient of exterior wall and a heat transfer coefficient of roof. The related information of an indoor energy-using equipment may include a lighting equipment power density and an electrical equipment power density. The performance and configuration information of a HVAC system may include a boiler heating efficiency and an indoor temperature set value.

In some embodiments, a template with highest similarity is determined according to the purpose of the target building, the applied ECM, and the type of HVAC system on the basis of the pre-established BES template library, and the determined template is further modified through the specified characteristic parameters of the target building, so that a corresponding simplified model is obtained. In the prior art, a modeling process for a target building often takes several months, but by the embodiment of this application, a modeling time can be greatly reduced, and the application effect can also be close to the performance of an accurate model.

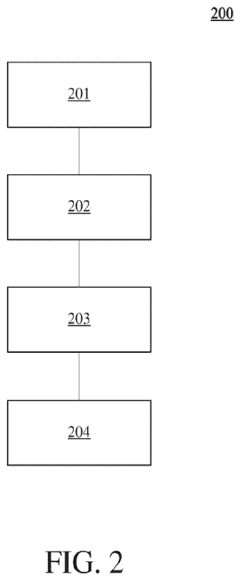

FIG. 2 is a flowchart of an example method 200 for evaluating energy conservation effect incorporating teachings of the present disclosure. As shown in FIG. 2, the method 200 for evaluating energy conservation effect includes:

Step 201: Obtain a first simplified model by the modeling method 100, the first simplified model referring to a simplified BES model of a target building in a case of applying a current ECM condition.

Step 202: Obtain a second simplified model by the modeling method 100, the second simplified model referring to a simplified BES model of the target building in a case of applying a planned ECM condition.

In some embodiments, position information of the target building may be received, and the position information of the target building may be inputted into a BES solver. In some embodiments, weather information of the target building may be received, and the weather information may be inputted into the BES solver.

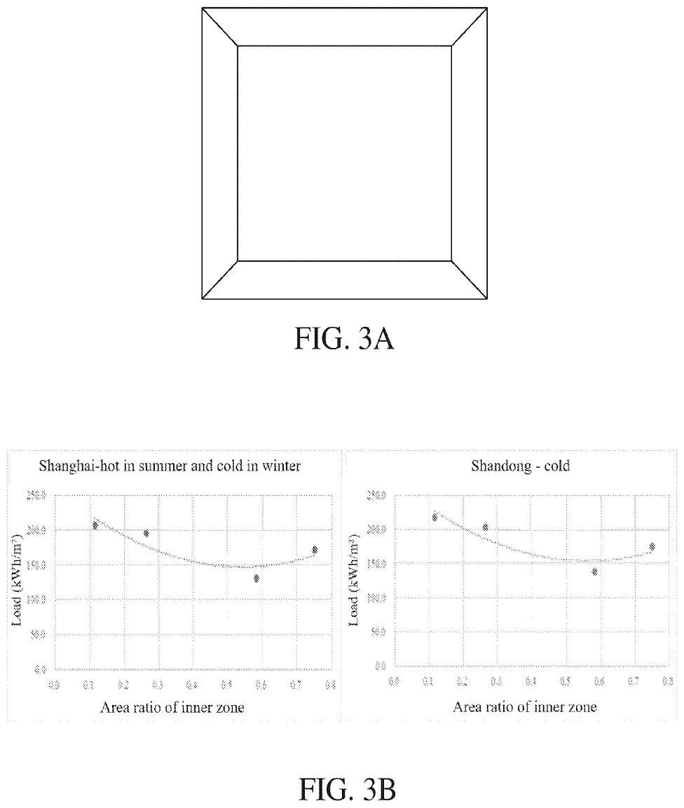

Step 203: Respectively predict energy consumption of the first simplified model and energy consumption of the second simplified model by the BES solver. In some embodiments, after respectively predicting energy consumption of the first simplified model and energy consumption of the second simplified model by the BES solver, in a case of detecting that there is an error between specified basic building information corresponding to the first simplified model and that corresponding to the target building, the energy consumption of the first simplified model is corrected by a preset correction formula, to obtain corrected energy consumption of the first simplified model. In a case of detecting that there is an error between specified basic building information corresponding to the second simplified model and that corresponding to the target building, the energy consumption of the second simplified model is corrected by the preset correction formula, to obtain corrected energy consumption of the second simplified model. It is assumed that when an error is detected between an area ratio of an inner zone of building or orientation information corresponding to the generated simplified model and that corresponding to the target building, the energy consumption may be corrected by the preset correction formula. In an embodiment, the shape of the simplified model is a pre-set cube with a specified aspect ratio. Since the aspect ratio of the target building may be different from that of the simplified model, the energy consumption calculated based on the simplified model may be different from an actual value of the target building. FIG. 3A is a schematic diagram of an area ratio of an inner zone of building according to an embodiment of this application. A length-and-width characteristic of a single story of building, that is, a building area of a single story, is reflected in parameters of the area ratio of the inner zone of building. As shown in FIG. 3A, when the ratio of the inner zone of building is larger, it means that the building area of a single story is larger, that is, the building is squatter when a building height is constant. Conversely, when the ratio of the inner zone of building is smaller, it means that the building area of a single story is smaller, that is, the building is slenderer when the building height is constant. An influence of a building shape on the energy consumption is mainly caused by an influence of the building shape on cooling and heating loads of an air conditioning. Therefore, in order to explore the influence of the area ratio of the inner zone of building on the energy consumption of the building, it is necessary to fundamentally study the influence of the building shape on an air conditioning load. Firstly, an annual air conditioning load of building models with different shapes, that is, different area ratios of the inner zone of building, is simulated by a building energy consumption simulation software, and a relationship between the area ratio of the inner zone of building and the annual total load of building shown in FIG. 3B is obtained. Considering an influence of climate change on a building load, the relationships between the area ratio of the inner zone of building and the annual total load of building in a region which is hot in summer and cold in winter such as Shanghai and a cold region such as Shandong are calculated respectively.

The relationship between the building load and the area ratio of the inner zone of building basically conforms to a quadratic curve function shown in formula (1):

$$load = {ax}^{2} + b x + c \qquad ( 1 )$$

x is an area ratio of an inner zone of building, and different regression coefficients may be obtained for different climate regions, thereby realizing the modification of the energy consumption by the area ratio of the inner zone of building. As shown in formula (2):

$${EUI}^{′} = {EUI}_{0} \times \frac{{load}^{′}}{{load}_{0}} = {EUI}_{0} \times \frac{a {x}^{′2} + {bx}^{′} + c}{a {x}_{0}^{2} + b {x}_{0} + c} \qquad ( 2 )$$

EUI₀ is an energy consumption result before the modification, EUI′ is an energy consumption result after the modification. Correspondingly, load₀ is a building load before the modification, load′ is a building load after the modification, x₀ is an area ratio of an inner zone of building of an original model, and x′ is an area ratio of an inner zone of an actual building.

The energy consumption of the simplified model may be further modified by formula (2), thereby enabling the energy consumption result to be more in line with the energy consumption characteristic of the actual building.

In some embodiments, the energy consumption of the first simplified model and the energy consumption of the second simplified model may be shown monthly, quarterly, or annually, and may be outputted as a table form.

Step 204: Calculate, according to the energy consumption of the first simplified model and the energy consumption of the second simplified model, energy consumption that the target building can save in a case of transitioning from the current ECM condition to the planned ECM condition. A difference between the energy consumption of the second simplified model and the energy consumption of the first simplified model may be obtained, so that energy consumption that can be saved may be obtained.

In some embodiments, by using the modeling method 100, the simplified BES model applying the current ECM condition of the target building and the simplified model applying the planned ECM condition are respectively obtained, and then the energy consumption that can be saved in a case of transitioning to the planned ECM condition is calculated according to the energy consumption of corresponding to the two. The energy consumption of different target buildings under different ECM conditions and the energy consumption that the target building can save in a case of transitioning from the current ECM condition to the planned ECM condition can be accurately, rapidly, and cost-effectively evaluated.

In some embodiments, the energy consumption that the target building can save in a case of transitioning from the current ECM condition to the planned ECM condition may be converted to a corresponding carbon emission reduction amount through a carbon emission factor database. The energy consumption that the target building can save in a case of transitioning from the current ECM condition to the planned ECM condition may be converted to a corresponding energy cost reduction amount through an energy price database. In this way, the user can be provided with reference in more dimensions, and it is more conducive for the user to comprehensively evaluate the effect of energy conservation and emission reduction of building.

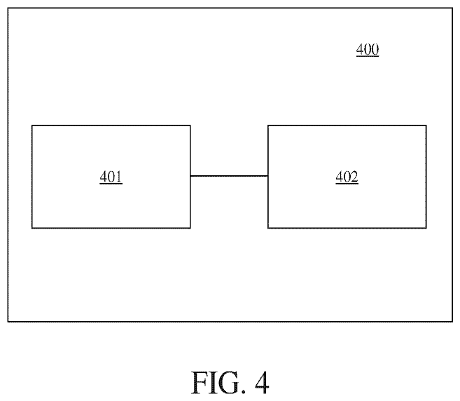

An another example embodiments includes an electronic device. FIG. 4 is a schematic diagram of an example electronic device 400 incorporating teachings of the present disclosure. As shown in FIG. 4, the electronic device 400 includes a processor 402 and a memory 401. The memory 401 stores instructions, and the instructions, when being executed by the processor 402, implement the method 100 or 200 described above.

At least one processor 402 may include a microprocessor, an application-specific integrated circuit (ASIC), a digital signal processor (DSP), a central processing unit (CPU), a graphics processing unit (GPU), a state machine, and the like. Embodiments of a computer-readable medium include, but are not limited to, a floppy disk, a CD-ROM, a magnetic disk, a memory chip, a ROM, a RAM, an ASIC, a configured processor, an all-optical medium, all magnetic tapes or other magnetic mediums, or any other medium from which a computer processor can read instructions. In addition, computer-readable mediums in various other forms can transmit or carry the instructions to a computer, and include routers, private or public networks, or other wired and wireless transmission devices or channels. The instructions may include code in any computer programming language, including C, C++, C#, Visual Basic, java, and JavaScript.

Another example embodiment includes a computer-readable medium. The computer-readable medium stores computer-readable instructions. The computer-readable instructions, when executed by a processor, cause the processor to perform one of more of the foregoing modeling methods or methods for evaluating an energy conservation effect. Embodiments of the computer-readable medium include a floppy disk, a hard disk, a magneto-optical disk, an optical disc (for example, a CD-ROM, a CD-R, a CD-RW, a DVD-ROM, a DVD-RAM, a DVD-RW, or a DVD-RW), a magnetic tape, a non-volatile storage card, and a ROM. Optionally, the computer-readable instructions may be downloaded by a communication network from a server computer or a cloud.

Not all steps and modules in the procedures and the system structure diagrams are necessary, and some steps or modules may be omitted according to an actual requirement. An execution sequence of the steps is not fixed and may be adjusted according to requirements. The system structure described in the embodiments may be a physical structure or a logical structure. That is, some modules may be implemented by the same physical entity, or some modules may be implemented by a plurality of physical entities, or may be implemented by some components in a plurality of independent devices together.

What is claimed is:

1. A modeling method, comprising:
establishing a BES template library according to a building purpose, an ECM combination, and a type of HVAC system, the BES template library comprising a plurality of BES model templates;
receiving a purpose, an applied ECM, a type of HVAC system, and specified characteristic parameters of a target building;
loading a first template by retrieving a template with highest similarity to the target building from the BES template library according to the purpose, the applied ECM, and the type of HVAC system of the target building; and
obtaining a simplified BES model of the target building by modifying corresponding characteristic parameters in the first template according to the specified characteristic parameters of the target building.

2. The method according to claim 1, wherein establishing a BES template library according to a building purpose, an ECM combination, and a type of HVAC system comprises:
selecting a plurality of specified building purposes, a plurality of specified ECM combinations, and a plurality of specified types of HVAC system, wherein the plurality of specified types of HVAC system comprise: a plurality of specified heating and cooling source system forms, a plurality of specified terminal unit forms, and a plurality of specified transmission and distribution system forms;
obtaining all combinations by performing arrangement and combination among any one of the plurality of specified building purposes, any one of the plurality of specified ECM combinations, any one of the plurality of specified heating and cooling source system forms, any one of the plurality of specified terminal unit forms, and any one of the plurality of specified transmission and distribution system forms;
establishing BES model templates corresponding to each combination of the all combinations; and
inputting all the BES model templates into the BES template library.

3. The method according to claim 2, wherein:
the plurality of specified building purposes comprise: an office purpose and a commercial purpose;
the plurality of specified ECM combinations comprise: all combinations obtained by performing arrangement and combination among adopting/not adopting daylighting control, adopting/not adopting a heat recovery ventilation technology, and adopting/not adopting an air-side economizer technology;
the plurality of specified heating and cooling source system forms comprise: a boiler/chiller system, a chiller with central heating system, a ground source heat pump system, and an air source heat pump system;
the plurality of specified terminal unit forms comprise: a FCU system, and a VAV system; and
the plurality of specified transmission and distribution system forms comprise: a constant speed pump system, a variable speed pump system, and a secondary pump system.

4. The method according to claim 1, wherein loading a template with highest similarity to the target building from the BES template library comprises:
retrieving a same template as the target building from the BES template library; or
retrieving a template with highest similarity to the target building from the BES template library based on a Pearson correlation coefficient method.

5. The method according to claim 1, wherein the specified characteristic parameters of the target building comprise:
basic building information, building envelope information, related information of an indoor energy-using equipment, and performance and configuration information of a HVAC system.

6. The method according to claim 1, further comprising, before receiving specified characteristic parameters of a target building:
performing a sensitivity analysis on each characteristic parameter in the characteristic parameters affecting energy consumption in the building, the sensitivity analysis referring to a calculation of a degree of influence on the energy consumption;
sorting results of the sensitivity analysis corresponding to each characteristic parameter from high to low; and
selecting a preset number of characteristic parameters as the specified characteristic parameters of the target building.

7. The method according to claim 1, further comprising, after receiving a purpose, an applied ECM, a type of HVAC system, and specified characteristic parameters of a target building:
in a case that there is a first characteristic parameter in the specified characteristic parameters of the target building, the first characteristic parameter referring to a characteristic parameter that has no accurate reference value or is not measurable, and
obtaining a calibrated first characteristic parameter by a simulation model calibration algorithm according to a historical energy bill of the target building.

8. A method for evaluating an energy conservation effect, the method comprising:
obtaining a first simplified model by the modeling method according to claim 1, the first simplified model referring to a simplified BES model of a target building in a case of applying a current ECM condition;
obtaining a second simplified model by the modeling method according to claim 1, the second simplified model referring to a simplified BES model of the target building in a case of applying a planned ECM condition;
respectively predicting energy consumption of the first simplified model and energy consumption of the second simplified model by a BES solver; and
calculating, according to the energy consumption of the first simplified model and the energy consumption of the second simplified model, energy consumption that the target building saves in a case of transitioning from the current ECM condition to the planned ECM condition.

9. The method according to claim 8, further comprising, before respectively predicting energy consumption of the first simplified model and energy consumption of the second simplified model by a BES solver:
receiving position information or weather information of the target building; and
inputting the position information or weather information of the target building into the BES solver.

10. The method according to claim 8, further comprising, after the-respectively predicting energy consumption of the first simplified model and energy consumption of the second simplified model by a BES solver:
correcting, in a case of detecting that there is an error between specified basic building information corresponding to the first simplified model and that corresponding to the target building, the energy consumption of the first simplified model by a preset correction formula, to obtain corrected energy consumption of the first simplified model; and
correcting, in a case of detecting that there is an error between specified basic building information corresponding to the second simplified model and that corresponding to the target building, the energy consumption of the second simplified model by the preset correction formula, to obtain corrected energy consumption of the second simplified model.

11. The method according to claim 8, further comprising, after calculating the energy consumption that the target building saves in a case of transitioning from the current ECM condition to the planned ECM condition:
converting, through a carbon emission factor database, the energy consumption that the target building saves in a case of transitioning from the current ECM condition to the planned ECM condition to a corresponding carbon emission reduction amount; and/or
converting, through an energy price database, the energy consumption that the target building saves in a case of transitioning from the current ECM condition to the planned ECM condition to a corresponding energy cost reduction amount.

12-13. (canceled)
